(19) United States
(12) Patent Application Publication
(10) Pub. No.: US 2002/0172355 A1
(43) Pub. Date: Nov. 21, 2002

(54) High-performance booth-encoded montgomery module

(76) Inventors: Chih-Chung Lu, Taipei (TW); An-Yeu Wu, Taipei (TW); Shau-Yin Tseng, Hsinchu (TW)

Correspondence Address: BACON & THOMAS, PLLC, 4th Floor, 625 Slaters Lane, Alexandria, VA, 22314-1176, US

(21) Appl. No.: 09/824,754

(22) Filed: Apr. 4, 2001

(51) Int. Cl. H04L 9/28

(52) U.S. Cl. 380/28

(57) ABSTRACT

There is disclosed a high-performance Booth-encoded Montgomery module for performing the computation of A*B*r⁻¹ (mod N). A Booth encoder is provided for receiving two bits of A to perform a Booth encoding process, so as to produce a Booth code. A multiplicand selector is provided for receiving B and the Booth code so as to select a multiplicand. A first carry propagate adder is provided for adding the output of the multiplicand selector and a previous computation result to output. A multiplexer is provided for receiving four inputs 0, N, 2N, and 3N from a lookup table and selecting one of the inputs to output. A second carry propagate adder is provided for adding the outputs of the first carry propagate adder and the multiplexer to output. A shifter is provided for shifting the output from the second carry propagate adder to right by two bits, so as to produce a computation result.

### BACKGROUND OF THE INVENTION

1. Field of the Invention

The present invention relates to the field of RSA cryptosystem and, more particularly, to a high-performance Booth-encoded Montgomery module for RSA cryptsystem.

2. Description of Related Art

As the use of network continues to grow, it is very frequently for the user to transmit data over the networks. To protect important data from the invasion of network hackers, the security of network becomes an essential issue. Recently, the public key cryptography becomes very popular due to its flexibility. The most well-known public key cryptography is the RSA cryptosystem, which is named after its inventors, Rivest, Shamir and Adleman.

In RSA cryptosystem, the public and private key-pairs are functions of two large (128 digit or even larger) prime numbers. To generate the two key-pairs, two large prime numbers, P and Q, are randomly chosen. To maximize the security, the word-length of P and Q are chosen equal and then compute:

N=P*Q.

Then, an encryption key K_{E} is randomly chosen such that K_{E} and (P−1)(Q−1) are relatively prime. Accordingly, the decryption key K_{D} can be computed using extended Euclidean algorithm that satisfies:

K_{D}=K_{E}⁻¹ mod ((P−1)(Q−1)).

Note that the number K_{D} and N are also relatively prime. The number K_{E} and N are the encryption key (or public key) used for data encryption, and the number (K_{D}, N) is the decryption key used for decryption. Such a RSA cryptsystem is illustrated in FIG. 8. After the RSA keys are generated, the original message is encrypted by performing the computation of:

C=M^{K}^{_{E′}}mod N,

where M is the original message (plaintext) and C is the encrypted message (ciphertext). To decrypt the encrypted data, the following computation is performed:

M′=C^{K}^{_{D}} mod N,

where M′ is the decrypted message. It should be the same with original message M.

In the realization of RSA encryptsystem, a long word-length, generally more than 512 bits, is usually employed to meet the security requirement. Hence, it calls for very large silicon area in VLSI implementations, and the speed performance is limited by the long word-length too. Therefore, fast exponential computation becomes increasingly important for its wide use in RSA encryption. There are many methods, such as H-algorithm, L-algorithm, etc., proposed to accelerate the exponential computation. Besides, most recent RSA designs employ the Montgomery modular multiplication algorithm as kernel operation in high-performance exponent-computation algorithms. The Montgomery modular multiplication algorithm also plays an important role to improve the efficiency of RSA encryption and decryption operations.

The Montgomery modular multiplication algorithm is provided to compute the resulting n-bit number:

R=A*B*r⁻¹ mod N, (where r=2ⁿ)

required in the modular exponential algorithm, where A, B and N are the multiplicator, multiplicand, and modular number, respectively, and each has n bits. A typical Montgomery modular multiplication algorithm is as follows:

M(A,B,N) {P[0]=0;

for (i=0; i<n; i++)

{qᵢ=(P[i]+aᵢB) mod 2;

P[i+1]−(P[i]+aᵢB+qᵢN) div 2;

}

return P[n];

}.

A direct hardware implementation of such a Montgomery modular multiplication algorithm is shown in FIG. 9, which utilizes two carry propagate adders 91 and 92 (hereinafter abbreviated as CPAs) to achieve the operation. The first CPA 91 is provided for a multiplication operation, and receives a previous computation result and a result of aᵢ ANDed with B outputted from an AND logic 93 that receives the aᵢ and B. The second CPA 92 is provided for a modular operation, and receives the output of the result of the first CPA 91 and a result of qᵢ ANDed with N outputted from an AND logic 94 that receives the qᵢ and B (where qᵢ is directly derived by (P[i]+aᵢB) mod 2 to simply AND with N for optionally applying N to the CPA 92, and thus is not shown in the figure for simplification). The output of the CPA 92 is shifted to right by one bit with a shifter 95, so as to divide the output result by 2, thereby generating the computation result for one iteration.

To complete a 512-bit Montgomery modular multiplication, there are 512 iterations required, which will spend a lot of time. As a result, the speed of a 512-bit RSA en/decryption is still far slower than the current network transmission bandwidth.

U.S Pat. No. 6,061,706 granted to Gai et al. discloses a “Systolic linear-array modular multiplier with pipeline processing elements” for improving the computation speed. However, each processing element in such a modular multiplier only performs the modular multiplication operation for 2 bit*1 bit in a clock cycle. Therefore, the improvement is limited. Accordingly, it is desirable to provide a novel modular multiplication architecture to further improve the computation speed of the RSA en/decryption.

### SUMMARY OF THE INVENTION

The object of the present invention is to provide a high-performance Booth-encoded Montgomery module for RSA cryptsystem capable of increasing the computation speed.

To achieve the object, the high-performance Booth-encoded Montgomery module of the present invention is provided to perform a computation of A*B*r⁻¹ (mod N), where A, B and N are the multiplicand, multiplicator, and modular number, respectively. The module includes: a Booth encoder for receiving two bits of A to perform a Booth encoding process, so as to produce a Booth code for output; a multiplicand selector for receiving B and the Booth code output from the Booth encoder so as to select a multiplicand based on the Booth code for output; a first carry propagate adder for adding the output of the multiplicand selector and a previous computation result to output; a multiplexer for receiving four inputs 0, N, 2N, and 3N from a lookup table and selecting one of the inputs to output; a second carry propagate adder for adding the outputs of the first carry propagate adder and the multiplexer to output; and a shifter for shifting the output from the second carry propagate adder to right by two bits, so as to produce a computation result.

Other objects, advantages, and novel features of the invention will become more apparent from the following detailed description when taken in conjunction with the accompanying drawings.

### BRIEF DESCRIPTION OF THE DRAWINGS

FIGS. 1A˜1E schematically illustrates the design methodology of the high-performance Booth-encoded Montgomery module for RSA cryptsystem in accordance with the present invention;

FIG. 2 is the detailed circuit diagram of a single stage of the Booth-encoded Montgomery module in accordance with the present invention;

FIG. 3 schematically illustrates the pipelining stages of the Booth-encoded Montgomery module in accordance with the present invention;

FIG. 4 is the detailed circuit diagram of a Montgomery cell shown in FIG. 3;

FIG. 5 shows a 512-bit Montgomery unit;

FIG. 6 is the timing diagram of data-flow in Montgomery module;

FIG. 7 shows an overall scalable Montgomery module;

FIG. 8 shows a RSA cryptsystem; and

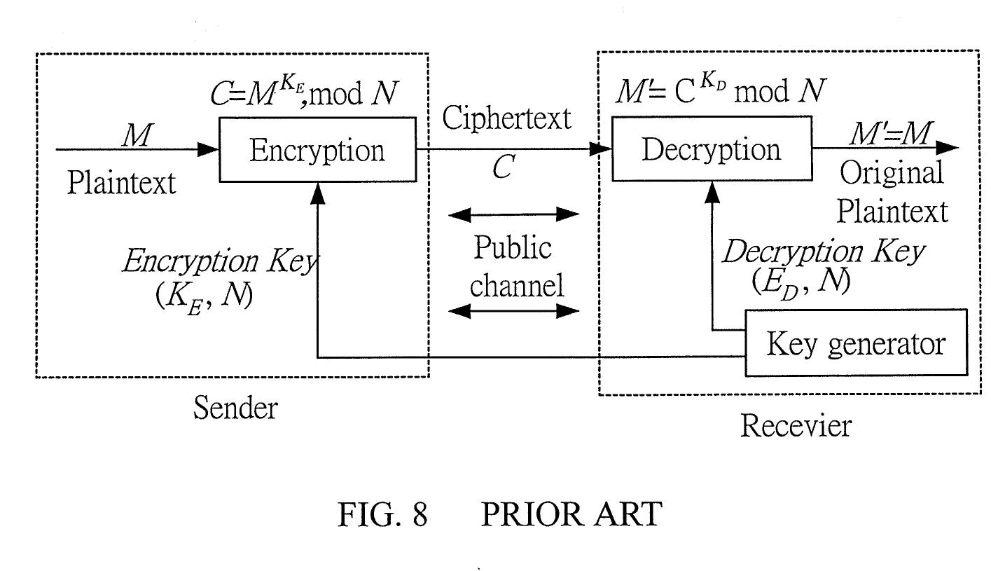

FIG. 9 shows a direct hardware implementation of the Montgomery modular multiplication algorithm.

### DETAILED DESCRIPTION OF THE PREFERRED EMBODIMENT

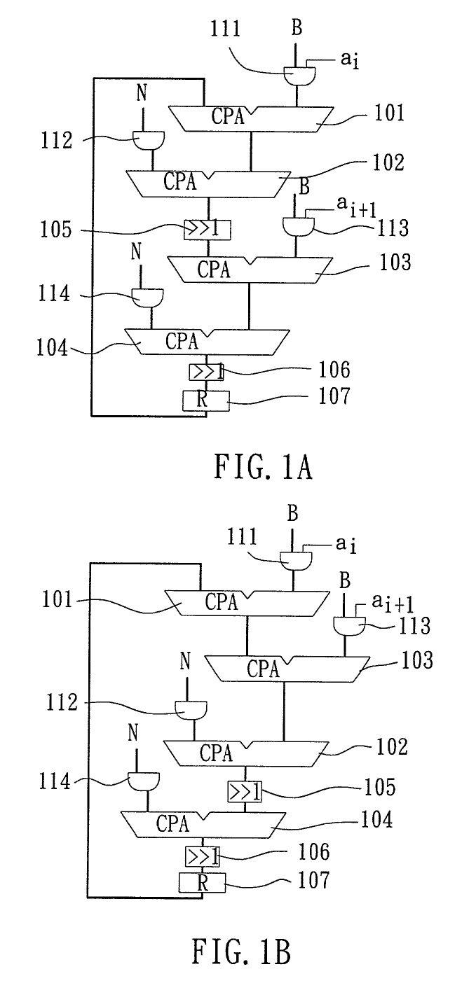

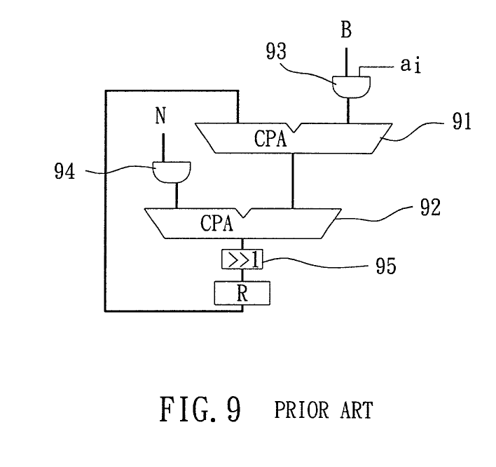

With reference to FIGS. 1A to 1E, there is shown the design methodology for the high-performance booth-encoded Montgomery module in accordance with a preferred embodiment of the present invention. The present Montgomery module is derived from the direct hardware implementation of the Montgomery modular multiplication algorithm as shown in FIG. 9, which is referred to as a direct-implemented Montgomery module and performs one iteration for the modular multiplication. As known, to perform n-bit modular multiplication, this direct-implemented Montgomery module has to be executed n times for the required n iterations.

In order to reduce the number of iterations to complete the modular multiplication, the direct-implemented Montgomery module is expanded one time by taking loop-unrolling technique thereon, so as to reduce the number of iteration from n to n/2. The resultant architecture is shown in FIG. 1A, which has four CPAs 101˜104, four AND logic 111˜114, two shifters 105 and 106, and a register 107. The first two CPAs 101 and 102 and the associated AND logic 111 and 112 and shifter 105 are provided to form a hardware architecture same as the direct-implemented Montgomery module. Similarly, the other two CPAs 103 and 104 and the associated AND logic 113 and 114 and shifter 106 are provided to form a hardware architecture same as the direct-implemented Montgomery module. The register 107 is provided to buffer the computation result for the next iteration.

In the hardware architecture shown in FIG. 1A, the CPAs 101 and 103 are used for multiplication operations and the CPAs 102 and 104 are used for modular operations. In order to apply Booth-encoded technique, the sequence of addition is changed as illustrated in FIG. 1B, wherein two CPAs 101 and 103 used for multiplication are arranged together.

Since the two CPAs 101 and 103 are used for multiplication operations, it is applicable to take radix 4 Booth-encoding technique thereon for encoding the input data {a_{i 1}, aᵢ, aᵢ₊₁} to Booth code, so as to eliminate one CPA and also shorten the critical path. The resultant hardware architecture is shown in FIG. 1C, which employs a Booth encoder 12, a multiplicand selector 13 and a CPA 11 to perform the same operation as the two CPAs 101 and 103 shown in FIG. 1B. The Booth encoder 12 receives aᵢ and aᵢ₊₁ (and a previous bit aᵢ₋₁) to perform a Booth encoding process, which is known to those skilled in the art and thus a detailed description is deemed unnecessary. The encoded output and the B are applied to the multiplicand selector 13 for selecting 2B, B, 0, −B, or −2B as a multiplicand. The output of the multiplicand selector 13 is given to the CPA 11.

As to the other two CPAs 102 and 104, they are used to selectively add N and 2N in the computation process. Therefore, it is applicable to integrate the two CPAs 102 and 104 into one CPA 14 together with a multiplexer 15 which receives four inputs 0, N, 2N, 3N form a lookup table, as shown in FIG. 1D. The outputs of the multiplexer 15 and the CPA 11 are applied to the CPA 14 for being added together and further being shifted to right by two bits with the shifter 106, so as to produce the computation result for one iteration. Moreover, the lookup table can be simplified by re-ordering the inputs of the multiplixer 15 in such a manner that the input 2N can be produced by shifting the input N to left with a shifter 16 so that only three inputs 0, N and 3N are required. The final architecture is shown in FIG. 1E.

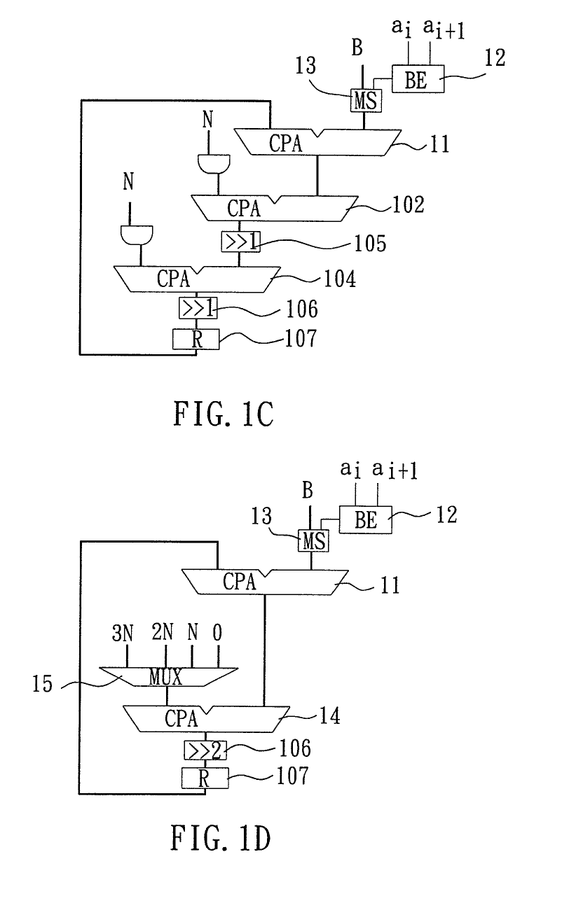

The design methodology helps to derive the high-performance Booth-encoded Montgomery module in accordance with the present invention. FIG. 2 shows the detailed circuit diagram of a single stage of the Booth-encoded Montgomery module. As shown, the Booth encoder 12 is used to provide the Booth encoding function Booth( ), wherein the possible value of ci are 2, 1, 0, −1, or −2, and three bits of the multiplicator will be encoded to 3-bit Booth-code. The multiplicand selector 13 is used to select the multiplicand by Booth-code. Similar to Booth multiplier, the selected multiplicand can be 2B, B, 0, −B, −2B. The modular selector 21 is used to provide the function Sel( ) for deciding the value that maybe 0, N, 2N, or 3N, to be added to the CPA 14 from the 3 bits of data. The overall operation can be summarized in pseudo C-like code as follows:

Booth(A)
{ q₀=0; aₙ=0; aₙ₊₁=0;

for (i=0;i<=n;i=i+2)

{ switch({aᵢ₊₁aᵢ q_{i/2}})

{ case 0: c_{i/2}=0; break;
case 1: c_{i/2}=1; break;
case 2: c_{i/2}=1; break;
case 3: c_{i/2}=2; break;
case 4: c_{i/2}=−2; break;
case 5: c_{i/2}=−1; break;
case 6: c_{i/2}=−1; break;
case 7: c_{i/2}=0; break;
}
q_{i/2+1}=aᵢ₊₁;

}
return C={c_{n/2},c_{n/2-1},c_{n/2-2},. . . c₁,c₀}

}
Sel(qᵢ,n₁)
{ r₀=qᵢ[0]; /* q_{I}={ qᵢ[1], qᵢ[0] } */

if(n₁ == 0)

r₁ = qᵢ[1] ⊕ qᵢ[0];

else

r₁ = qᵢ[1];

return R={r₁, r₀};

}
M3(A,B,N)
{ C= Booth(A) ={c_{n/2}, c_{n/2-1}, c_{n/2-2},...c₁, c₀,};

/* cᵢ ={2,1,0,−1,−2}; */

P[0]=0;
For (i=0;i<=n/2;i=i++)
{ qᵢ=(P[i]+ cᵢ* B) mod 4;

R=Sel(qᵢ,n₁);

P[i+1]=(P[i]+ cᵢ*B+R*N) div 4;

}
return P[n/2+1];
}.

The implementation of the modular selector 21 is very simple by using only two logic gates. After the operation of Sel( ) function, the output of the two least significant bits (LSB) of P[i+1] must be zero valued. Then, these two LSBs can be removed by simply shifting P[i+1] to right by 2 bits, i.e. dividing P[i+1] by 4. Accordingly, there are only n/2 iterations required, while the hardware complexity is about the same as original architecture.

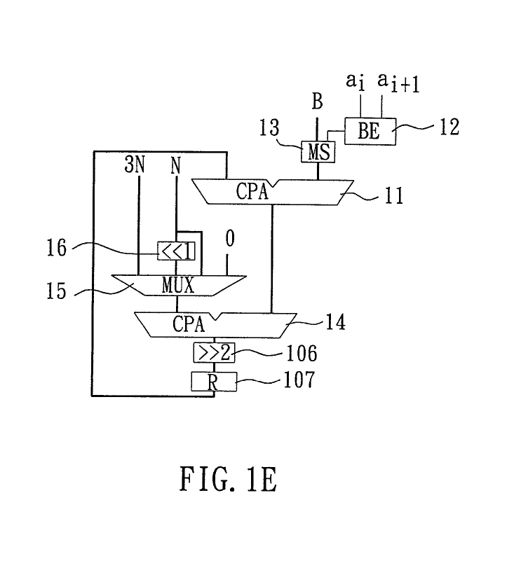

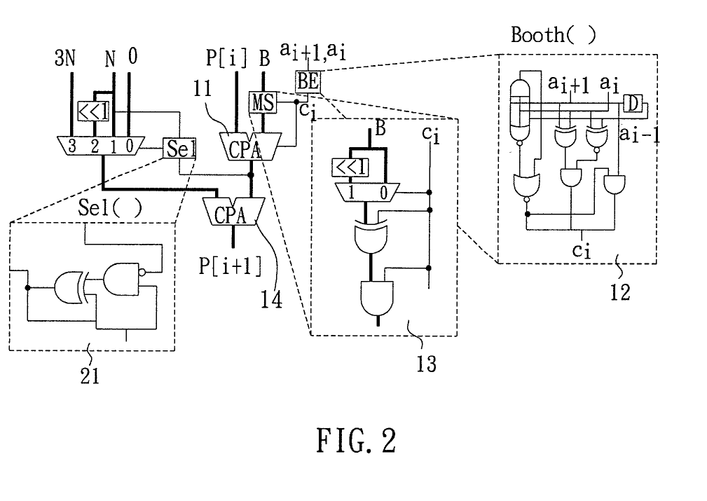

The use of the present Booth-encoded Montgomery module can be optimized by using pipeline technique. To illustrate the optimization steps, a 4-bit Booth-encoded Montgomery module is given as an example, which uses the modular N and 3N, multiplicand and Booth-encoded multiplicator as the input data to complete the Montgomery modular multiplication in one single clock for one stage. By applying the operation to all stages, one Montgomery modular multiplier can be formed. To accelerate the speed of operation, several pipeline stages can be inserted to shorten the circuit path by applying the folding technique. Such a Montgomery modular multiplier architecture with dedicated pipelining stages is shown in FIG. 3, wherein each row of full adders (FAs) represents a CPA, and the dotted lines represent the pipelining stages. As shown, in each CPA, every four full adders are grouped together, such that the two corresponding full adder groups of the two CPAs 11 and 14 construct a Montgomery cell 31 for being used as a pipelining stage. The detailed circuit diagram is shown in FIG. 4, wherein the input data, which includes multiplicator, multiplicand, R, N, and control signal P, are fed digit-serially. Such a circuit results in a pure systolic architecture, so as to minimize the driving problem and effectively reduce the critical path.

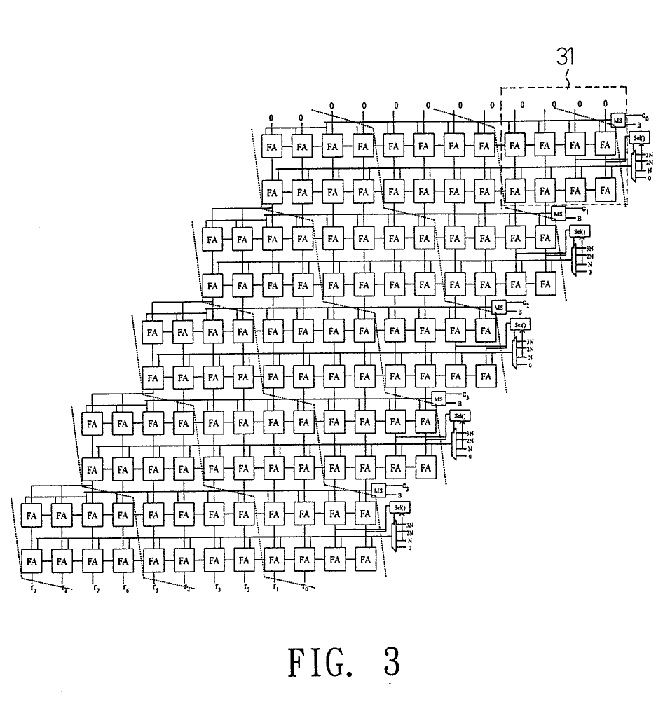

By expanding the above architecture, a 512-bit architecture can be constructed as shown in FIG. 5. The 512-bit Montgomery modular multiplier requires a total of 256+1 Montgomery cells 31 to construct a 512-bit Montgomery module. It will take 1*(256+1) clock cycles (1 clock cycle/each cell) to finish the 512-bit Montgomery operation.

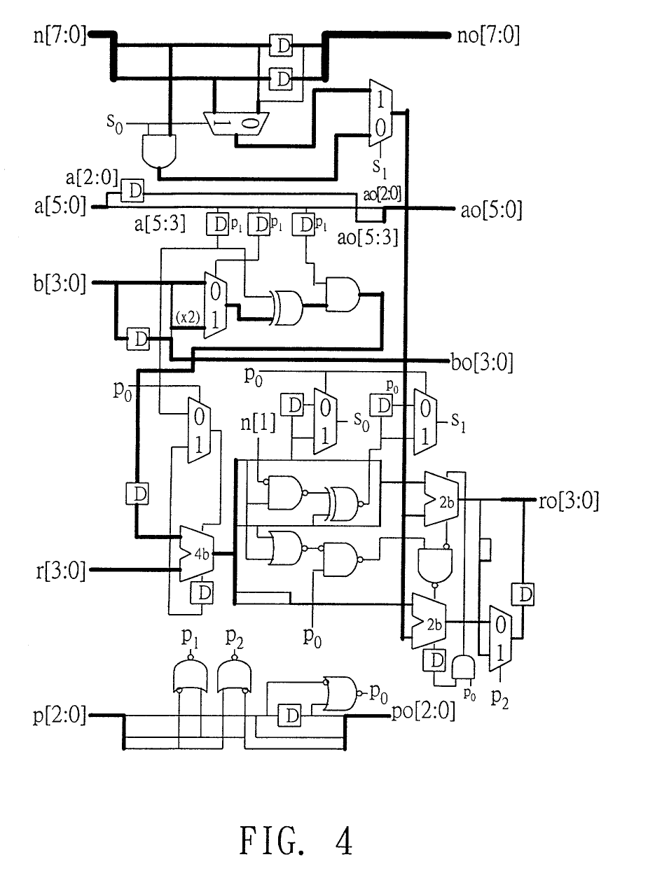

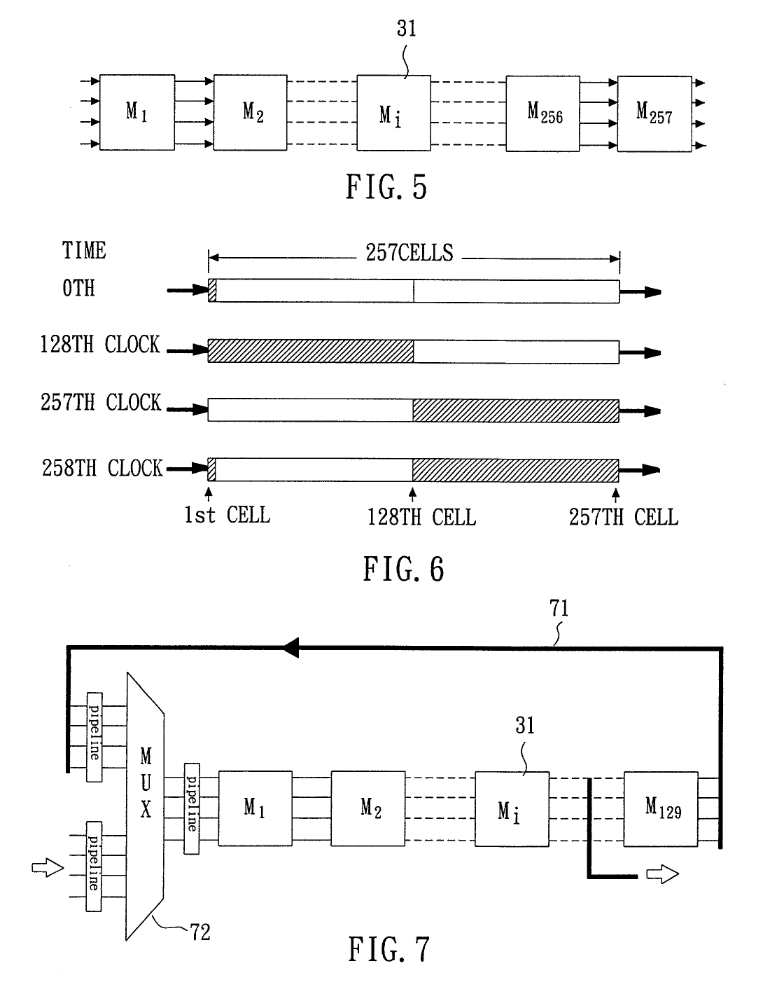

By examining the architecture in FIG. 5 and its timing diagram shown in FIG. 6, it is found that only ½ of total 257 M-cells are running in the same time, so that almost ½ of total cells are idle at a particular moment. Hence, as shown in FIG. 7, it is applicable to add a new data loop 71 and a multiplexer 72 to reuse those Montgomery cells 71. As a result, the cell number can be reduced by ½ and make the present Montgomery modular multiplier a full-utilization one, thereby significantly reducing the required hardware complexity.

Although the present invention has been explained in relation to its preferred embodiment, it is to be understood that many other possible modifications and variations can be made without departing from the spirit and scope of the invention as hereinafter claimed.

What is claimed is:

1. A high-performance Booth-encoded Montgomery module for performing the computation of A*B*r₋₁ (mod N), where A, B and N are the (n-bit) multiplicator, (n-bit) multiplicand, and (n-bit) modular number, respectively, and r=2ⁿ, the module comprising:
a Booth encoder for receiving two bits of A to perform a Booth encoding process, so as to produce a Booth code for output;
a multiplicand selector for receiving B and the Booth code output from the Booth encoder so as to select a multiplicand based on the Booth code for output;
a first carry propagate adder for adding the output of the multiplicand selector and a previous computation result to output;
a multiplexer for receiving four inputs 0, N, 2N, and 3N from a lookup table and selecting one of the inputs to output;
a second carry propagate adder for adding the outputs of the first carry propagate adder and the multiplexer to output; and
a shifter for shifting the output from the second carry propagate adder to right by two bits, so as to produce a computation result.

2. The high-performance Booth-encoded Montgomery module as claimed in claim 1, further comprising a register for buffering the computation result.

3. The high-performance Booth-encoded Montgomery module as claimed in claim 1, wherein the multiplicand selected by the multiplicand selector is 2B, B, 0, −B, or −2B.

4. The high-performance Booth-encoded Montgomery module as claimed in claim 3, wherein the Booth code is 3-bit.

5. The high-performance Booth-encoded Montgomery module as claimed in claim 3, wherein the input 2N is produced by shifting the input N to left with a shifter so that only three inputs 0, N and 3N are required in the lookup table.

6. The high-performance Booth-encoded Montgomery module as claimed in claim 1, further comprising a modular selector for selecting 0, N, 2N, or 3N to be added to the second carry propagate adder.

7. The high-performance Booth-encoded Montgomery module as claimed in claim 1, wherein each carry propagate adder has a row of full adders, and every four full adders are grouped together, such that two corresponding full adder groups of the first and second carry propagate adders form a Montgomery cell for being used as a pipelining stage.

8. The high-performance Booth-encoded Montgomery module as claimed in claim 7, which has a plurality of Montgomery cells for constructing a Montgomery modular multiplier.

9. The high-performance Booth-encoded Montgomery module as claimed in claim 8, further comprising a multiplexer and a data loop to reuse the Montgomery cells, so that the cell number can be reduced by ½.
